(19) United States
(12) Patent Application Publication
(10) Pub. No.: US 2007/0282943 A1
(43) Pub. Date: Dec. 6, 2007

(54) Relocation services via a shared service center

(76) Inventor: Lena C. Rincones, The Woodlands, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/442,925

(22) Filed: May 30, 2006

(51) Int. Cl. G06F 15/16

(52) U.S. Cl. 709/203

(57) ABSTRACT

A method for providing a relocation service via a Shared Service Center (SSC) is presented. The method includes defining a block of relocation services to be offered from a Shared Service Center (SSC); setting a benchmark for the block of relocation services, wherein the benchmark defines how many hours are expected to be needed to provide the block of relocation services from the SSC to a relocating client; scoring the benchmark according to actual delivery of past instances of the block of relocation services; and adjusting the benchmark according to the scoring of the benchmark.

### BACKGROUND OF THE INVENTION

1. Technical Field

The present invention relates in general to the field of shared service centers, and in particular to the use of shared service centers for providing relocation services. Still more particularly, the present invention relates to a service delivery method and system for providing multi-level initial and on-going service to relocating clients.

2. Description of the Related Art

The process of relocating employees of an enterprise has historically been handled in-house by the enterprise's local human resources department, or else the relocating employee is “left to fend for himself” in the moving process. When moves are handled by the enterprise's human resources department (“HR”), the process is often inflexible and expensive, since HR usually only has rudimentary knowledge of the complexity of such a move, particularly when the move is to another country. When the move is handled entirely by the employee (“left to fend for himself”), the toll in stress and cost is often so high that, at worst, the enterprise ends up losing the employee when he quits, or, at best, the employee takes an extensive amount of time assimilating into his new environment, thus resulting in a loss of productivity.

### SUMMARY OF THE INVENTION

The present invention recognizes the need for a delivery method and system to optimally provide relocation assistance, and thus provides a delivery method and system that includes, but is not limited to, defining a block of relocation services to be offered from a Shared Service Center (SSC); setting a benchmark for the block of relocation services, wherein the benchmark defines how many hours are expected to be needed to provide the block of relocation services from the SSC to a relocating client; scoring the benchmark according to actual delivery of past instances of the block of relocation services; and adjusting the benchmark according to the scoring of the benchmark.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an infrastructure context in which relocations services via Shared Service Centers (SSCs) are provided in accordance with the present invention;

FIG. 2 is a flow-chart of exemplary steps taken in establishing and utilizing relocation services in one or more SSCs;

FIG. 3 depicts an exemplary SSC computer which can be utilized in the SSC in accordance with the present invention;

FIG. 4 illustrates a software deploying service that is capable of deploying software to the SSC computer shown in FIG. 3 to implement the present invention;

FIGS. 5a-b are flow-chart showing steps taken to deploy software capable of executing the steps shown in FIG. 2;

FIGS. 6a-c are flow-charts showing steps taken to deploy in a Virtual Private Network (VPN) software that is capable of executing the steps shown in FIG. 2;

FIGS. 7a-b are flow-charts showing steps taken to integrate into an computer system software that is capable of executing the steps shown in FIG. 2; and

FIGS. 8a-b are flow-charts showing steps taken to execute the steps shown in FIG. 2 using an on-demand service provider.

### DETAILED DESCRIPTION OF THE PREFERRED EMBODIMENT

This present invention is a delivery method for providing relocation services to relocating employees and their families using a shared service center.

### Shared Service Centers

A shared service center (SSC) is comprised of the people, information, equipment, technology, and physical facilities needed to perform one or more business processes for one or more client enterprises by one or more provider enterprises. “Shared” thus refers to multiple processes, multiple clients, and/or multiple providers at each SSC. For example, a single SSC can perform various human resources processes (e.g., payroll, benefits, relocation, etc.) for diverse client enterprises via a primary outsourcer and several subcontractors.

SSCs can be insourced or outsourced. An insourced SSC is primarily for the benefit of the enterprise that owns it, though it may also serve other selected client enterprises. An outsourced SSC is primarily for the benefit of client enterprises, though it may also serve the enterprise that owns it. (Note that “insourcing” is from the owner enterprise's viewpoint while “outsourcing” is from the client enterprise's viewpoint.)

Elements of an SSC often are, but do not have to be, located at one physical site. For example, most workers may work on-site, while some have remote offices, and others are mobile—which means they establish connectivity and work from various locations as needed. Thus, calls routed between SSCs do not always terminate on-site at the destination SSC. Alternatively, most workers may work from home in a virtual SSC. Distinct SSCs exist when they have separate management, perform different processes, serve different geographic areas, handle different languages/cultures, etc.

SSCs can perform standardized or customized business processes. A standardized process is performed the same way for all service requests, while a customized process is performed in different ways for some requests. In practice, however, total standardization and full customization are end-points on a continuum.

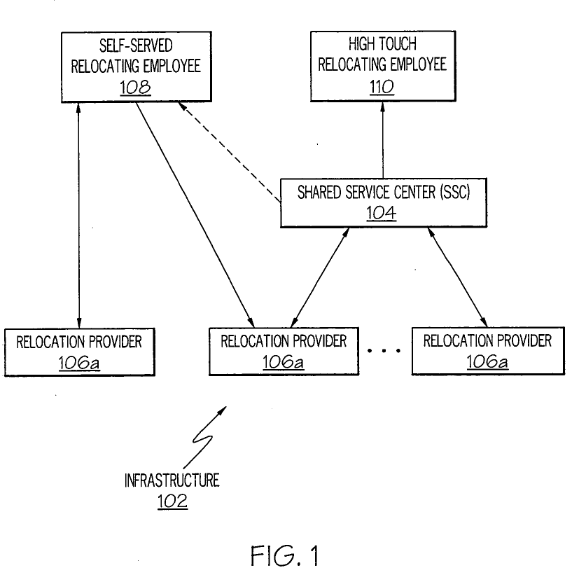

With reference then to FIG. 1, an exemplary SSC infrastructure 102 is depicted. Shared Service Center (SSC) 104 is able to directly communicate with multiple relocation providers 106a-n. As contemplated in the present invention, each relocation specialist 106 has access to a relocation specialist who is capable of providing one or more “on the ground” relocation services, such as locating housing (e.g., a realtor), finding a public or private school for the relocating employee and/or his/her dependants, providing immunizations that are required for entry into a destination (relocation) country, moving personal and household goods belonging to the relocating employee and his/her family, etc., working in partnership with pre-selected global suppliers managed by the relocation specialists on behalf of the relocating employee

As will be described below, SSC 104 can offer relocation services at different levels, including “self-service” and “high touch.” As the name implies, self-service services are primarily little more than access to relocation providers 106 that a self-served relocating employee 108 is authorized to utilize, per an authorization from the self-served relocating employee's employer. That is, self-service relocation services merely tell the self-served relocating employee 108 how to contact authorized relocation providers 106, after which the self-served relocating employee 108 must personally handle any coordination of services, payment, etc. directly with the authorized relocation providers(s) 106.

Conversely, high touch service includes the use of a one or more dedicated case managers who work at the SSC 104. These case managers (Relocation Specialist) “shield” a high touch relocating employee 110 from relocation providers 106, such that the high touch relocating employee 110 does not have to make any decisions about which services to use, how to coordinate the services provided by the relocation providers 106, etc. That is, the case manager (Relocation Specialists) in SSC 104, using a standardized relocation protocol established in a Service Delivery Method (SDM) that has been negotiated with the employer of the high touch relocating employee 110, guides the high touch relocating employee 110 through the moving process, as well as on-going services needed by the high touch relocating employee 110 while living as an expatriate in a foreign country, by orchestrating the needed services from the various relocation providers 106.

Unique aspects of the SSC implemented relocation services include, but are not limited to, 1) providing initial and on-going relocation assistance to expatriates; 2) setting benchmarks (predictions) for service requirements (both self-service and high touch); 3) scoring (determining the accuracy of predicted service requirements) the benchmarks; and 4) adjusting the service requirements according to benchmark scores.

### Providing On-Going Relocation Assistance to Expatriates

The present invention goes beyond providing simple transactional service to relocation of client employees. That is, rather than define the SSC presented relocation service as simply multiple transactions (e.g., scheduling a moving van, locating a house, enrolling a dependent child in a school, obtaining travel visas, etc.), the SSC presented relocation service is defined as temporal (i.e., number of hours) blocks of service. For example, an SDM (contract negotiated between the SSC owner and the employer of the relocating employee) may define self-service for a self-served relocating employee 108 as being 15-20 hours of service over the course of 1-3 months During this time period (1-3 months) and subject to the time limitations (15-20 hours), the self-served relocating employee 108 is allowed to utilize SSC 104 to obtain relocating guidelines, access relocation checklists, locate the names and contact information for various relocation providers 106, etc.

If, however, the SDM calls for high touch service, then the temporal block of service may be 50-60 hours of service per family over the entire length of the relocating employee's tour of duty in a foreign location, or at least for some period of time that is longer than that afforded to a self-served relocating employee, such as 3-6 months. During this service period, the high touch relocating employee interfaces only with one dedicated Case Manager (relocation specialist) in the SSC 104, who oversee and attend to the needs of the high touch relocating employee.

Whether established for self-served or high-touch relocating employees, these blocks of relocation services define benchmarks for the enterprise that operates the SSC 104 and provides the relocating services. These benchmarks have two main functions. First, they are used in pricing a Service Delivery Method (SDM), which as stated above is a contract between the operator of the SSC services and the employer of relocating employees. Second, these benchmarks are later scored according to the actual delivery of past instances of the block(s) of relocation services. If the SDM fails to meet the needs of the relocating employees (i.e., allows for too few hours of service), or if the SDM is too expensive (i.e., allows for too many unused hours of service), then the scored benchmark can be used to adjust future SDMs with a specific customer or all future customers.

Ideally, the SDM matches the exact amount budgeted for each relocating employee. For example, assume that an employer is not interested in investing much money into a relocation of an employee, and only has a limited budget for the move. In this situation, the operator of the SSC services will offer an SDM that includes a block of service, for each relocating employee, that only includes access to basic self-service services from the SSC. If, however, the employer wishes to invest heavily in the relocating employee (e.g., a top executive or a technical employee whose services need to be “up to speed” in the new assignment as soon as possible, without the employee being burdened with the stress of handling relocation details), then the employer may invest a higher amount. This budget would allow the operator of the SSC services to offer a high touch relocation service that includes one or more case managers as described herein.

### Benchmarking of Services

As noted above, the relocating services can be benchmarked, in order to effectively determine appropriate levels of service. Such benchmarking is based on hours of service provided to each relocating employee (and his/her family), rather than the number of transactions involved.

In order to assist the operator of the SSC services in staffing and setting SDM prices, calendar and geographic considerations are also benchmarked. For example, consider the difference between relocating to the United States of America (USA) compared to relocating to a Central America country. In the USA, school years are from August to June. In Central America, school years are from February to December. While the break between the end and start of a school year account for only one-fourth of the year (i.e., three months), two-thirds of relocation moves traditionally occur during this period. Thus, the vacation break (which requires more relocation assistance) is different in the USA (June-August) than in Central America (December-February). As such, the operator of the SSC services must staff accordingly, and/or adjust the cost of the SDM during these peak demand periods.

Another benchmark that needs to be maintained is the maximum number of open cases at any point in time. For example, for high touch services, there may be a cap of 12 total open cases at any one time, with an additional cap of four new cases per month. For self-service services, however, fewer resources of the SSC are needed. Thus, a higher cap (e.g., 25) on open cases with no more than 8-10 new cases per month may be acceptable to the operator of the SSC services.

### Scoring of Benchmarks

All benchmarks are scored to fine tune the SDM, pricing, staffing needs, etc. This scoring includes tracking not only how many hours are used (or unused) by a relocating employee, but also what specific services are used per package. For example, consider a relocating employee who is using a basic self-service relocating service. This basic self-service relocating service may include a relocation checklist, a webpage for all authorized relocation providers 106 available (either at the employee's expense of the employer's expense) to the self-service relocating employee, and links on the webpage to other websites for specific relocation providers s 106. By tracking which services are used, the SSC operator is able to adjust the available services and their prices to the employer in future SDMs.

Thus, the scoring is based on the number of benchmarked hours used, as well as which services in the block of service are used. As such, the scored benchmarks identify how effectively the services provided by the service providers are being delivered. While benchmarks can be scored universally (for a particular block of service regardless of which customer is using the block of service), alternatively benchmarking can be performed for each customer (e.g., an employer of a group of relocating employees). Thus, the scoring (grading) of the benchmarks for a particular customer can demonstrate to that customer that the proper blocks of relocation services have or have not been selected.

Note also that scoring can be broken up according to stages in the relocating process. That is, each stage in a relocating process (either for self-service or high-touch) has key actions that are identified, such as arranging for a mover to pack and move belongings, enrolling dependents in school, finding and obtaining a lease on housing, receiving proper immunizations, etc. Key actions are identified for four stages in the relocation process. In one embodiment, these stages are specific for high touch relocating employees.

The first stage is the preparatory stage, in which immunizations and visas are obtained, moving transportation arranged (including buying airline tickets, etc.), housing leases are finalized both for the employee-owned house (which is to be leased out while the employee is on foreign assignment), as well as new housing (in which the employee will live in the foreign country). The second stage is the transition stage, including arrangements for temporary housing, handling actual move and transportation issues, etc. The third stage is the expatriation stage, in which assistance is provided in an on-going manner, handling issues such as lease renewals, locating physicians for new medical conditions (e.g., pregnancies), assimilating newly arrived dependents into schools, houses of worship, etc. The fourth stage is the repatriation stage, in which the employee returns to his/her home country at the end of his/her tour of duty, and includes the same processes as the first and second stage.

Key actions in each stage are monitored and tracked to ensure timely completion, facilitating a successful transition as the relocating employee moves from one stage to the next.

### Adjusting of Service Requirements

As services are monitored and tracked for their effectiveness (in providing services to either self-served or high touch relocating employees), the SDM can be adjusted between the employer of the relocating employee and the owner of the SSC.

In addition, such monitoring and tracking allows the owner of the SSC to adjust resources, including hardware, software, office infrastructure, as well as personnel. That is, by tracking the benchmarks described above, the SSC owner can more accurately predict how many personnel will be needed during peak times of the year or day, as well as what office infrastructure (hardware, software, office space, furniture, support staff, office supplies, etc.) are needed to meet future service demands.

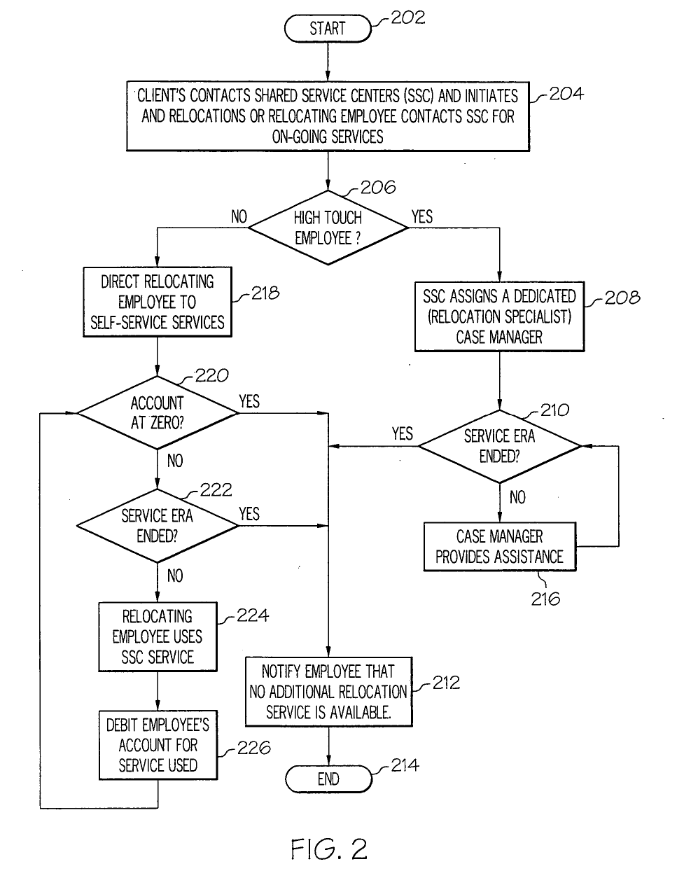

With reference now to FIG. 2, a flow-chart is presented showing an overview of the features of the presently presented relocation services via an SSC. After initiator block 202, a relocating employee contacts the SSC (block 204), either on the Web or by telephone. It is assumed at this stage that an SDM has been formed between the employer of the relocating employee and the operator of the SSC that is providing the relocation services. This SDM defines whether the relocating employee is to be a self-served relocating employee or a high-touch relocating employee, as defined and described above, and such a determination is made by querying a database of relocation service-eligible employees in the SSC (query block 206). If the relocating employee is a high-touch employee, then he directly contacts a relocation case manager who is assigned to him (block 208). The relocation case manager (relocation specialist) provides all service interface between the high-touch employee and relocation providers s (106 in FIG. 1), thus providing special “hand holding” service to the high-touch employee throughout the term of the service. Such assistance is predicated on the service era still being in effect (query block 210). That is, while some service era last throughout the entire term of the expatriation period, other service eras (as defined by the SDM) may be for a more limited time period. If the service era is ended, then the relating employee is so notified (block 212), and the process ends (terminator block 214). Otherwise, the case manager handles the service request (block 216), including providing services that the relocating employee did not know he needed or was afforded. By providing the employee more than he expected, the case manager demonstrates to the high-touch employee how important that employee's welfare is to the employer of the relocating employee.

If the relocating employee is not eligible for high-touch service (again at query block 206), then the employee is a self-service employee who is directed to the self-service services of the SSC (block 218), which are described above. In a preferred embodiment, self-service relocating employees have a “bank account” of hours that they can spend using the SSCs relocation self-services. If these hours have been used up (query block 220), the employee is so notified (block 212) and the process ends (terminator block 214). Similarly, there is likely a time era during which the self-service employee may use the SSCs relocation self-services. If this time era has expired (query block 222), then the employee is so notified (block 212) and the process ends (terminator block 214). Otherwise, the employee uses the self-service services of the SSC (block 224), and his “bank account” is debited for the amount of time used (block 226).

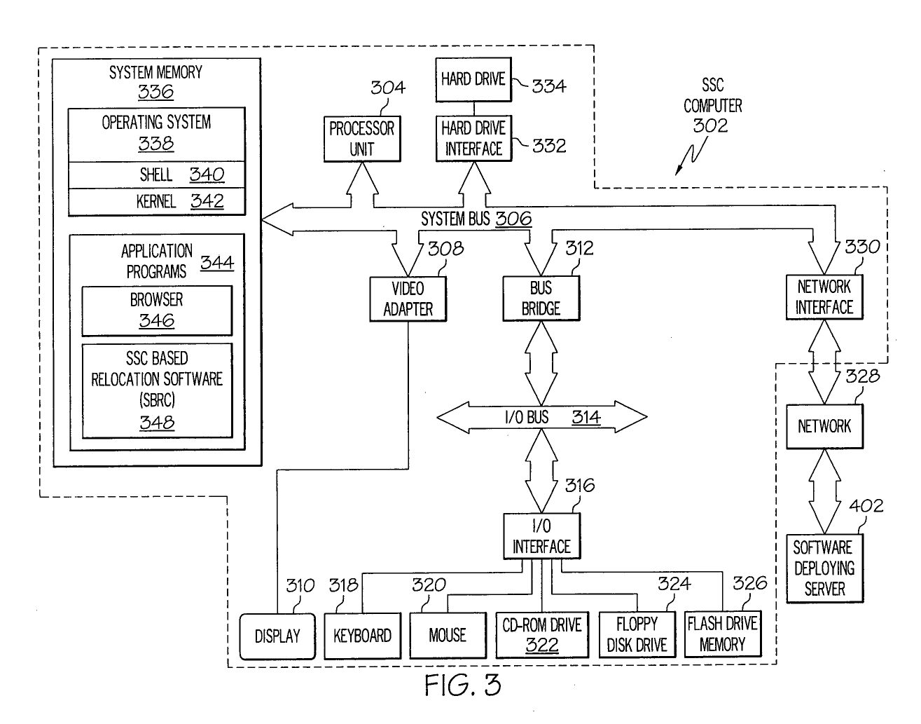

With reference now to FIG. 3, there is depicted a block diagram of an exemplary Shared Service Center (SSC) computer 302, in which the present invention may be utilized. SSC computer 302 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/0 interface 316 may be any known to those skilled in the art of computer architecture, including but not limited to Universal Serial Bus (USB) ports.

SSC computer 302 is able to communicate with a software deploying server 402 via a network 328 using a network interface 330, which is coupled to system bus 306. Network 328 may be an external network such as the Internet, or an internal network such as an Ethernet or a Virtual Private Network (VPN).

A hard drive interface 332 is also coupled to system bus 306. Hard drive interface 332 interfaces with a hard drive 334. In a preferred embodiment, hard drive 334 populates a system memory 336, which is also coupled to system bus 306. Data that populates system memory 336 includes SSC computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., SSC computer 302) to send and receive network messages to the Internet using HyperText Transfer Protocol (HTTP) messaging, thus enabling communication with software deploying server 402.

Application programs 344 in SSC computer 302's system memory also include a SSC Based Relocation Software (SBRC) 348. SBRC 348 includes code for implementing the processes described in FIG. 2. In one embodiment, SSC computer 302 is able to download SBRC 348 from software deploying server 402.

The hardware elements depicted in SSC computer 302 are not intended to be exhaustive, but rather are representative to highlight essential components required by the present invention. For instance, SSC computer 302 may include alternate memory storage devices such as magnetic cassettes, Digital Versatile Disks (DVDs), Bernoulli cartridges, and the like. These and other variations are intended to be within the spirit and scope of the present invention.

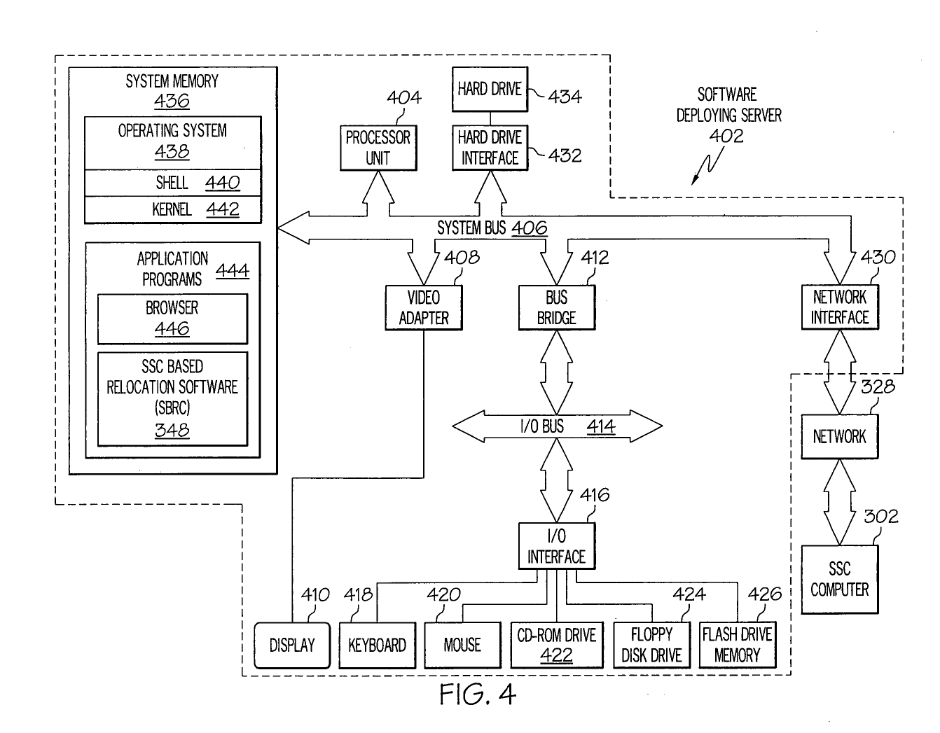

As noted above, SBRC 348 can be downloaded to SSC computer 302 from software deploying server 402, shown in exemplary form in FIG. 4. Software deploying server 402 includes a processor unit 404 that is coupled to a system bus 406. A video adapter 408 is also coupled to system bus 406. Video adapter 408 drives/supports a display 410. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk-Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Software deploying server 402 is able to communicate with SSC computer 302 via network 328 using a network interface 430, which is coupled to system bus 406. Access to network 328 allows software deploying server 402 to deploy SBRC 348 to SSC computer 302.

System bus 406 is also coupled to a hard drive interface 432, which interfaces with a hard drive 434. In a preferred embodiment, hard drive 434 populates a system memory 436, which is also coupled to system bus 406. Data that populates system memory 436 includes software deploying server 402's operating system 438, which includes a shell 440 and a kernel 442. Shell 440 is incorporated in a higher level operating system layer and utilized for providing transparent user access to resources such as application programs 444, which include a browser 446, and a copy of SBRC 348 described above, which can be deployed to SSC computer 302.

The hardware elements depicted in software deploying server 402 are not intended to be exhaustive, but rather are representative to highlight essential components required by the present invention. For instance, software deploying server 402 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, software deploying server 402 performs all of the functions associated with the present invention (including execution of SBRC 348), thus freeing SSC computer 302 from having to use its own internal computing resources to execute SBRC 348.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

Thus, the method described herein, and in particular as shown and described in FIG. 2, can be deployed as a process software from software deploying server 402 (shown in FIG. 4) to SSC computer 302 (shown in FIG. 3).

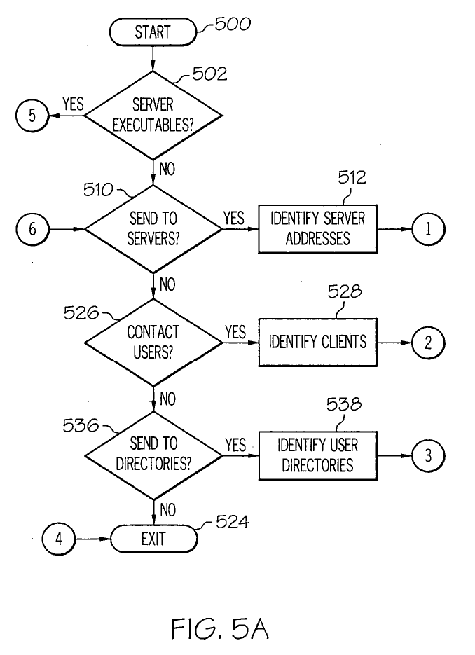

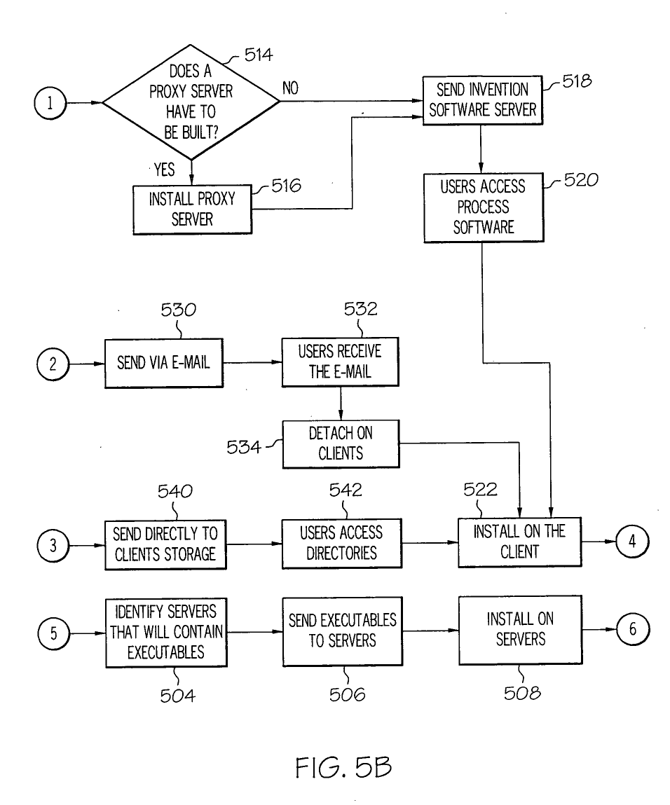

Referring then to FIGS. 5a-b, step 500 begins the deployment of the process software. The first thing is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying though the use of a shared file system (block 506). The process software is then installed on the servers (block 508).

Next, a determination is made on whether the process software is to be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 520). Another embodiment is to have the servers automatically copy the process software to each client and then run the installation program for the process software at each client computer. The user executes the program that installs the process software on his client computer (i.e., SSC computer 302) (block 522) then exits the process (terminator block 524).

In query step 526, a determination is made whether the process software is to be deployed by sending the process software to users via e-mail. The set of users where the process software will be deployed are identified together with the addresses of the user client computers (block 528). The process software is sent via e-mail to each of the users' client computers (block 530). The users then receive the e-mail (block 532) and then detach the process software from the e-mail to a directory on their client computers (block 534). The user executes the program that installs the process software on his client computer (block 522) then exits the process (terminator block 524).

Lastly a determination is made on whether the process software will be sent directly to user directories on their client computers (query block 536). If so, the user directories are identified (block 538). The process software is transferred directly to the user's client computer directory (block 540). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his client computer (block 522) and then exits the process (terminator block 524).

### VPN Deployment

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

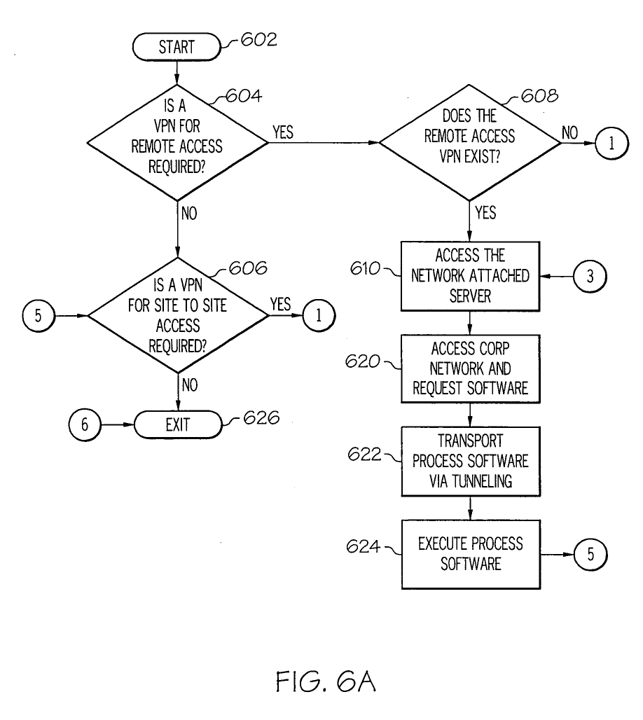

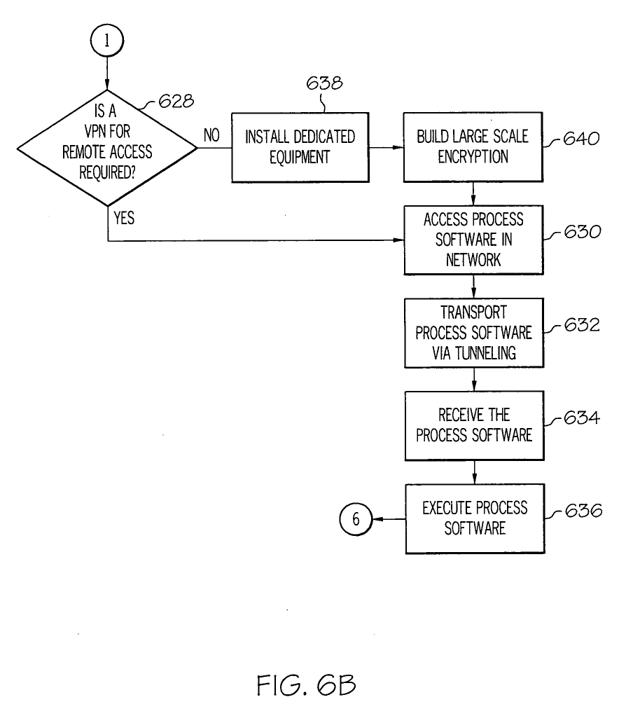

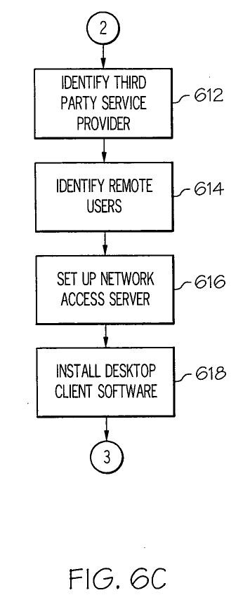

The process for such VPN deployment is described in FIGS. 6a-c. Initiator block 602 begins the Virtual Private Network (VPN) process. A determination is made to see if a VPN for remote access is required (query block 604). If it is not required, then proceed to query block 606. If it is required, then determine if the remote access VPN exists (query block 608).

If a VPN does exist, then proceed to block 610. Otherwise identify a third party provider that will provide the secure, encrypted connections between the company's private network and the company's remote users (block 612). The company's remote users are identified (block 614). The third party provider then sets up a network access server (NAS) (block 616) that allows the remote users to dial a toll free number or attach directly via a broadband modem to access, download and install the desktop client software for the remote-access VPN (block 618).

After the remote access VPN has been built or if it has been previously installed, the remote users can access the process software by dialing into the NAS or attaching directly via a cable or DSL modem into the NAS (block 610). This allows entry into the corporate network where the process software is accessed (block 620). The process software is transported to the remote user's desktop over the network via tunneling. That is, the process software is divided into packets and each packet including the data and protocol is placed within another packet (block 622). When the process software arrives at the remote user's desktop, it is removed from the packets, reconstituted and then is executed on the remote user's desktop (block 624).

A determination is then made to see if a VPN for site to site access is required (query block 606). If it is not required, then proceed to exit the process (terminator block 626). Otherwise, determine if the site to site VPN exists (query block 628). If it does exist, then proceed to block 630. Otherwise, install the dedicated equipment required to establish a site to site VPN (block 638). Then build the large scale encryption into the VPN (block 640).

After the site to site VPN has been built or if it had been previously established, the users access the process software via the VPN (block 630). The process software is transported to the site users over the network via tunneling (block 632). That is the process software is divided into packets and each packet including the data and protocol is placed within another packet (block 634). When the process software arrives at the remote user's desktop, it is removed from the packets, reconstituted and is executed on the site user's desktop (block 636). The process then ends at terminator block 626.

### Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

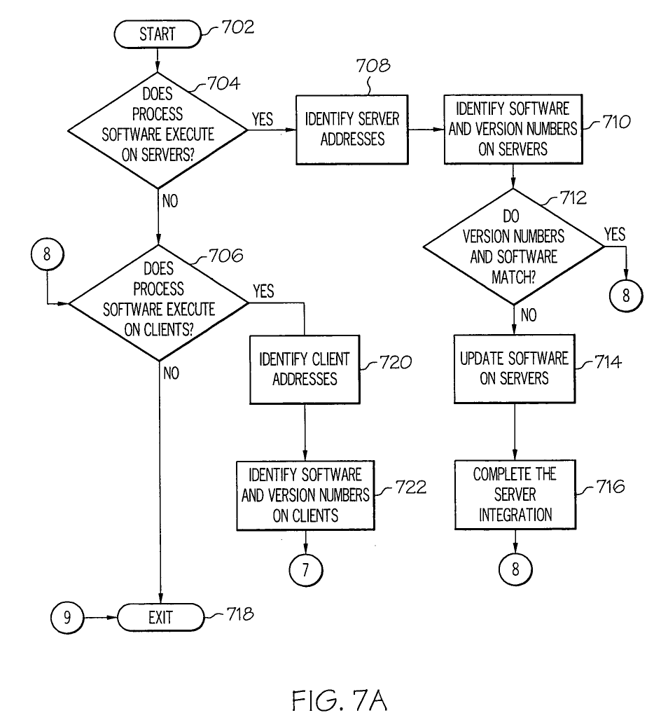

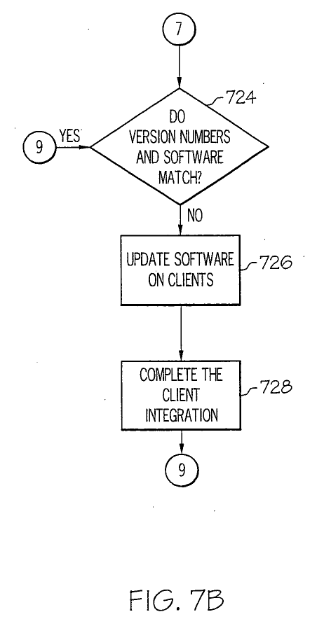

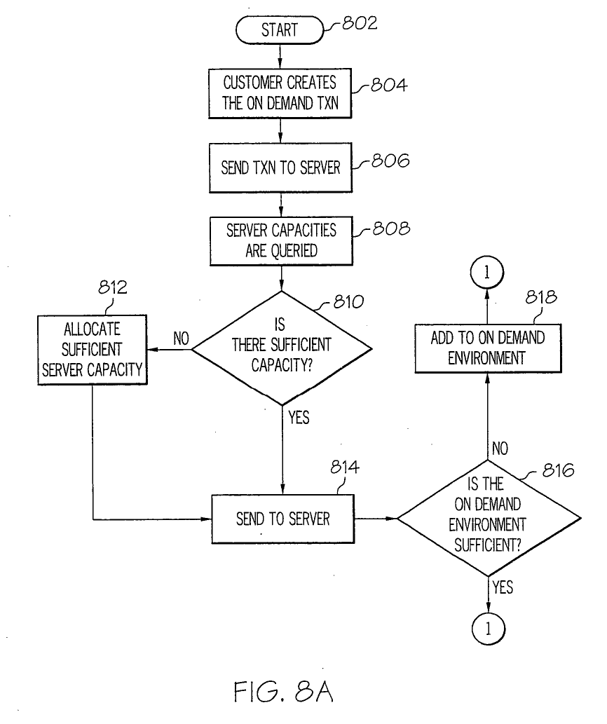

For a high-level description of this process, reference is now made to FIG. 7. Initiator block 702 begins the integration of the process software. The first tiling is to determine if there are any process software programs that will execute on a server or servers (block 704). If this is not the case, then integration proceeds to query block 706. If this is the case, then the server addresses are identified (block 708). The servers are checked to see if they contain software that includes the operating system (OS), applications, and network operating systems (NOS), together with their version numbers, which have been tested with the process software (block 710). The servers are also checked to determine if there is any missing software that is required by the process software in block 710.

A determination is made if the version numbers match the version numbers of OS, applications and NOS that have been tested with the process software (block 712). If all of the versions match and there is no missing required software the integration continues in query block 706.

If one or more of the version numbers do not match, then the unmatched versions are updated on the server or servers with the correct versions (block 714). Additionally, if there is missing required software, then it is updated on the server or servers in the step shown in block 714. The server integration is completed by installing the process software (block 716).

The step shown in query block 706, which follows either the steps shown in block 704, 712 or 716 determines if there are any programs of the process software that will execute on the clients. If no process software programs execute on the clients the integration proceeds to terminator block 718 and exits. If this not the case, then the client addresses are identified as shown in block 720.

The clients are checked to see if they contain software that includes the operating system (OS), applications, and network operating systems (NOS), together with their version numbers, which have been tested with the process software (block 722). The clients are also checked to determine if there is any missing software that is required by the process software in the step described by block 722.

A determination is made is the version numbers match the version numbers of OS, applications and NOS that have been tested with the process software (query block 724). If all of the versions match and there is no missing required software, then the integration proceeds to terminator block 718 and exits.

If one or more of the version numbers do not match, then the unmatched versions are updated on the clients with the correct versions (block 726). In addition, if there is missing required software then it is updated on the clients (also block 726). The client integration is completed by installing the process software on the clients (block 728). The integration proceeds to terminator block 718 and exits.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

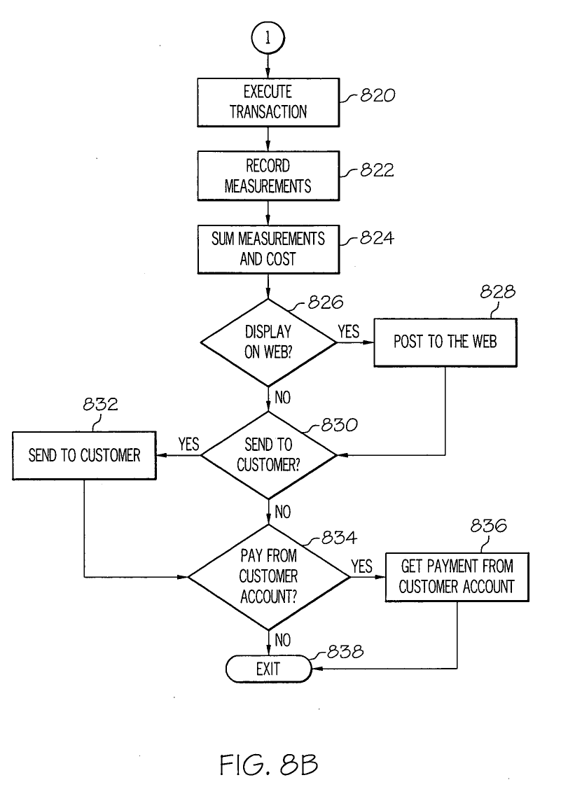

With reference now to FIGS. 8a-b, initiator block 802 begins the On Demand process. A transaction is created than contains the unique customer identification, the requested service type and any service parameters that further, specify the type of service (block 804). The transaction is then sent to the main server (block 806). In an On Demand environment the main server can initially be the only server, then as capacity is consumed other servers are added to the On Demand environment.

The server central processing unit (CPU) capacities in the On Demand environment are queried (block 808). The CPU requirement of the transaction is estimated, then the servers available CPU capacity in the On Demand environment are compared to the transaction CPU requirement to see if there is sufficient CPU available capacity in any server to process the transaction (query block 810). If there is not sufficient server CPU available capacity, then additional server CPU capacity is allocated to process the transaction (block 812). If there was already sufficient available CPU capacity then the transaction is sent to a selected server (block 814).

Before executing the transaction, a check is made of the remaining On Demand environment to determine if the environment has sufficient available capacity for processing the transaction. This environment capacity consists of such things as but not limited to network bandwidth, processor memory, storage etc. (block 816). If there is not sufficient available capacity, then capacity will be added to the On Demand environment (block 818). Next the required software to process the transaction is accessed, loaded into memory, then the transaction is executed (block 820).

The usage measurements are recorded (block 822). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 824).

If the customer has requested that the On Demand costs be posted to a web site (query block 826), then they are posted (block 828). If the customer has requested that the On Demand costs be sent via e-mail to a customer address (query block 830), then these costs are sent to the customer (block 832). If the customer has requested that the On Demand costs be paid directly from a customer account (query block 834), then payment is received directly from the customer account (block 836). The On Demand process is then exited at terminator block 838.

The present invention thus provides a relocation service via a Shared Service Center (SSC). In one embodiment, the invention utilizes a method that comprises the steps of: defining a block of relocation services to be offered from a Shared Service Center (SSC); setting a benchmark for the block of relocation services, wherein the benchmark defines how many hours are expected to be needed to provide the block of relocation services from the SSC to a relocating client; scoring the benchmark according to actual delivery of past instances of the block of relocation services; and adjusting the benchmark according to the scoring of the benchmark. Based on adjusted benchmarks, a Service Delivery Method (SDM) can be created with an employer of the relocating client for future relocation services, wherein the SDM is a contract that is negotiated between an SSC owner and the employer of the relocating client. The SDM may provide an option of providing either self-service services or high touch services to specifically classified relocating clients, wherein the self-service services provide only references to third-party service providers to the specifically classified relocating client, and wherein the high touch services include services of a dedicated case manager at the SSC, wherein the dedicated case manager provides a “live” and “high touch” interface between the specifically classified relocating client and third-party service providers such that the specifically classified relocating client has minimal contact with the third-party service provider, and wherein an employer of the specifically classified relocating client selects either the self-services or the high touch services based on a specifically classified relocating client's contracted service delivery model. The high touch services extend throughout an entire time that the relocating client is reassigned to a second and consequent foreign assignment location that is away from a home location, and wherein the high touch services are provided to the relocating client upon repatriation from the second and consequent foreign assignment location. If the relocating client is provided the self-service services only, the method further comprises: establishing with the SSC a monetary-based account for the relocating client; and debiting, thru third party providers and services, the monetary-based account every time the relocating client utilizes a service from the self-service services. The method may adjust the SDM according to unique geographic requirements for a relocation destination of the relocating client, and the SDM may be dependent on a maximum number (cap) of open cases for relocating clients that are permitted under the SDM.

In another embodiment, the method may comprise the steps of: providing an option of providing either self-service services or high touch services to specifically classified relocating employees of an employer enterprise, wherein the self-service services provide only references to third-party service providers to a specifically classified relocating employees, and wherein the high touch services include services of a dedicated case manager at the SSC, wherein the case manager provides a “live” and “high touch” interface between the specifically classified relocating employee and third-party service providers such that the specifically classified relocating employee has minimal contact with the third-party service provider. The employer of the specifically classified relocating client may select either the self-services or the high touch services based on a client's contracted service delivery model.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method for providing a relocation service via a Shared Service Center (SSC), the method comprising:
defining a block of relocation services to be offered from a Shared Service Center (SSC);
setting a benchmark for the block of relocation services, wherein the benchmark defines how many hours are expected to be needed to provide the block of relocation services from the SSC to a relocating client;
scoring the benchmark according to actual delivery of past instances of the block of relocation services; and
adjusting the benchmark according to the scoring of the benchmark.

2. The method of claim 1, further comprising:
based on adjusted benchmarks, developing a Service Delivery Method (SDM) with an employer of the relocating client for future relocation services, wherein the SDM is a contract that is negotiated between an SSC owner and the employer of the relocating client.

3. The method of claim 2, wherein the SDM provides an option of providing either self-service services or high touch services to specifically classified relocating clients, wherein the self-service services provide only references to third-party service providers to the specifically classified relocating client, and
wherein the high touch services include services of a dedicated case manager at the SSC, wherein the dedicated case manager provides a “live” and “high touch” interface between the specifically classified relocating client and third-party service providers such that the specifically classified relocating client has minimal contact with the third-party service provider, and wherein an employer of the specifically classified relocating client selects either the self-services or the high touch services based on a specifically classified relocating client's contracted service delivery model.

4. The method of claim 3, wherein the high touch services extend throughout an entire time that the relocating client is reassigned to a second and consequent foreign assignment location that is away from a home location, and wherein the high touch services are provided to the relocating client upon repatriation from the second and consequent foreign assignment location.

5. The method of claim 3, wherein the relocating client is provided the self-service services only, and wherein the method further comprises:
establishing with the SSC a monetary-based account for the relocating client; and
debiting, thru third party providers and services, the monetary-based account every time the relocating client utilizes a service from the self-service services.

6. The method of claim 2, further comprising:
adjusting the SDM according to unique geographic requirements for a relocation destination of the relocating client.

7. The method of claim 2, wherein the SDM is dependent on a maximum number (cap) of open cases for relocating clients that are permitted under the SDM.

8. A method for providing a relocation service via a Shared Service Center (SSC), the method comprising:
providing an option of providing either self-service services or high touch services to specifically classified relocating employees of an employer enterprise, wherein the self-service services provide only references to third-party service providers to a specifically classified relocating employees, and
wherein the high touch services include services of a dedicated case manager at the SSC, wherein the case manager provides a “live” and “high touch” interface between the specifically classified relocating employee and third-party service providers such that the specifically classified relocating employee has minimal contact with the third-party service provider.

9. The method of claim 8, wherein an employer of the specifically classified relocating client selects either the self-services or the high touch services based on a client's contracted service delivery model.

10. A computer-usable medium embodying computer program code for providing a relocation service via a Shared Service Center (SSC), the computer program code comprising computer executable instructions configured for:
defining a block of relocation services to be offered from a Shared Service Center (SSC);
setting a benchmark for the block of relocation services, wherein the benchmark defines how many hours are expected to be needed to provide the block of relocation services from the SSC to a relocating client;
scoring the benchmark according to actual delivery of past instances of the block of relocation services; and
adjusting the benchmark according to the scoring of the benchmark.

11. The computer-usable medium of claim 10, wherein the embodied computer program code further comprises computer executable instructions configured for:
based on adjusted benchmarks, developing a Service Delivery Method (SDM) with an employer of the relocating client for future relocation services, wherein the SDM is a contract that is negotiated between an SSC owner and the employer of the relocating client.

12. The computer-usable medium of claim 11, wherein the SDM provides an option of providing either self-service services or high touch services to specifically classified relocating clients, wherein the self-service services provide only references to third-party service providers to the specifically classified relocating client, and
wherein the high touch services include services of a dedicated case manager at the SSC, wherein the dedicated case manager provides a “live” and “high touch” interface between the specifically classified relocating client and third-party service providers such that the specifically classified relocating client has minimal contact with the third-party service provider, and wherein an employer of the specifically classified relocating client selects either the self-services or the high touch services based on a specifically classified relocating client's contracted service delivery model.

13. The computer-usable medium of claim 12, wherein the high touch services extend throughout an entire time that the relocating client is reassigned to a second and consequent foreign assignment location that is away from a home location, and wherein the high touch services are provided to the relocating client upon repatriation from the second and consequent foreign assignment location.

14. The computer-usable medium of claim 12, wherein the relocating client is provided the self-service services only, and wherein the embodied computer program code further comprises computer executable instructions configured for:
establishing with the SSC a monetary-based account for the relocating client; and
debiting, thru third party providers and services, the monetary-based account every time the relocating client utilizes a service from the self-service services.

15. The computer-usable medium of claim 11, wherein the embodied computer program code further comprises computer executable instructions configured for:
adjusting the SDM according to unique geographic requirements for a relocation destination of the relocating client.

16. The computer-usable medium of claim 11, wherein the SDM is dependent on a maximum number (cap) of open cases for relocating clients that are permitted under the SDM.

17. The computer-useable medium of claim 10, wherein the computer executable instructions are deployable to an SSC computer from a download server that is at a remote location.

18. The computer-useable medium of claim 10, wherein the computer executable instructions are provided by a download service provider to an SSC computer on an on-demand basis.
